(19) United States
(12) Patent Application Publication
(10) Pub. No.: US 2026/0019389 A1
(43) Pub. Date: Jan. 15, 2026

(54) WIRELESS NETWORK UPGRADE INQUIRY RESPONSE AND PLANNING FOR CUSTOMER EXPERIENCE IMPROVEMENT

(71) Applicant: T-Mobile USA, Inc., Bellevue, WA (US)

(72) Inventor: Chaitanya CHUKKA, Carol Stream, IL (US)

(21) Appl. No.: 18/769,351

(22) Filed: Jul. 10, 2024

(51) Int. Cl. H04L 51/02; H04L 41/5061

(52) U.S. Cl. CPC H04L 51/02; H04L 41/5061

(57) ABSTRACT

Solutions are disclosed that provide wireless network upgrade inquiry response and planning for customer experience improvement in a wireless network. Examples receive an inquiry from a user equipment (UE); use artificial intelligence (AI) to determine that the inquiry is relevant to performance of the wireless network; identify a location, within the wireless network, relevant to the inquiry (e.g., the serving base station); use AI to determine that a scheduled equipment upgrade will improve performance of the wireless network at the location relevant to the inquiry; and then use AI to respond to the inquiry with information about the scheduled equipment upgrade. For example, a customer engages a chatbot to complain about slow download speeds, and AI is able to identify that the serving base station has a planned upgrade that will improve data speeds, and inform the customer in the chat, in real time.

### BACKGROUND

When customers of wireless networks (e.g., cellular networks) become dissatisfied with their wireless service, such as due to low data speeds, difficulty connecting, dropped calls, or other problems, they may either call their wireless carrier to complain, or go to the carrier's website and initiate a chat session. In the event that a live customer service representative is not available, and the customer instead reaches an automated (voice-responsive) call handler or chatbot, the customer may become frustrated that there is no one with whom to speak, who is able to resolve the issue. The customer may then choose to move to a different wireless carrier, which is especially unfortunate if their existing wireless carrier had already made plans to improve capacity or coverage, or otherwise improve or restore network performance in the customer's area.

### SUMMARY

The following summary is provided to illustrate examples disclosed herein, but is not meant to limit all examples to any particular configuration or sequence of operations.

Solutions are disclosed that provide wireless network upgrade inquiry response and planning for customer experience improvement in a wireless network. Examples receive a first inquiry from a first user equipment (UE); determine, by a first artificial intelligence (AI) model, that the first inquiry is relevant to performance of the wireless network; based on at least determining that the first inquiry is relevant to performance of the wireless network, identify a first location, within the wireless network, relevant to the first inquiry; determine, using a second AI model, that a scheduled equipment upgrade will improve performance of the wireless network at the first location; and respond, using a third AI model, to the first inquiry with information about the scheduled equipment upgrade.

### BRIEF DESCRIPTION OF THE DRAWINGS

The disclosed examples are described below with reference to the accompanying drawing figures listed below, wherein:

FIG. 1 illustrates an exemplary architecture that advantageously provides wireless network upgrade inquiry response and planning for customer experience improvement;

FIG. 2 illustrates further detail for a conversation involving a customer of the wireless network of FIG. 1 and an artificial intelligence (AI) model;

FIG. 3 illustrates further detail for the conversation of FIG. 2;

FIG. 4 illustrates the use of crowdsourced data to assist in prioritizing network upgrades, in examples of the architecture of FIG. 1;

FIG. 5 illustrates training AI models that may be used within examples of the architecture of FIG. 1;

FIGS. 6 and 7 illustrate flowcharts of exemplary operations associated with the architecture of FIG. 1; and

FIG. 8 illustrates a block diagram of a computing device suitable for implementing various aspects of the disclosure.

Corresponding reference characters indicate corresponding parts throughout the drawings, where practical. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that provide wireless network upgrade inquiry response and planning for customer experience improvement in a wireless network. Examples receive an inquiry from a user equipment (UE); use artificial intelligence (AI) to determine that the inquiry is relevant to performance of the wireless network; identify a location, within the wireless network, relevant to the inquiry (e.g., the serving base station); use AI to determine that a scheduled equipment upgrade will improve performance of the wireless network at the location relevant to the inquiry; and then use AI to respond to the inquiry with information about the scheduled equipment upgrade. For example, a customer engages a chatbot to complain about slow download speeds, and AI is able to identify that the serving base station has a planned upgrade that will improve data speeds, and inform the customer in the chat, in real time. Chats may also be used to improve the AI and prioritize network upgrades (e.g., based on the number of customers who identify network performance concerns in the same locations).

Aspects of the disclosure thus improve the performance of wireless (cellular) networks by using customer feedback to prioritize network upgrades, and also improve customer satisfaction with wireless networks by leveraging AI to inform customers about scheduled upgrades in real-time. These advantageous results are accomplished, at least in part, by determining, by ant AI model, whether an inquiry is relevant to performance of a wireless network, and responding, using an AI model, to the inquiry with information about a scheduled equipment upgrade.

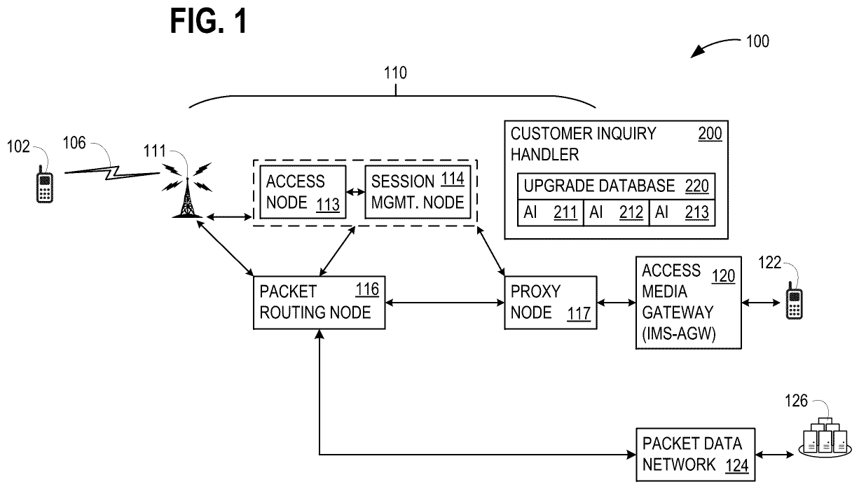

With reference now to the figures, FIG. 1 illustrates an exemplary architecture 100 that advantageously provides wireless network upgrade inquiry response and planning for customer experience improvement. A wireless network 110 is illustrated that is serving a UE 102. UE 102 may be an enhanced Mobile Broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network. In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 106 to communicate with a base station 111 of wireless network 110, such that base station 111 is the serving base station for UE 102 (providing the serving cell). In some scenarios, base station 111 may be referred to as a radio access network (RAN), and is located at a radio site. Wireless network 110 has an access node 113, a session management node 114, and other components (not shown). Wireless network 110 also has a packet routing node 116 and a proxy node 117. Access node 113 and session management node 114 are within a control plane of wireless network 110, and packet routing node 116 is within a data plane (a.k.a. user plane) of wireless network 110. Base station 111 is in communication with access node 113 and packet routing node 116. Access node 113 is in communication with session management node 114, which is in communication with packet routing node 116 and proxy node 117. Packet routing node 116 is in communication with proxy node 117 and packet data network 124.

In some 5G examples, base station 111 comprises a gNodeB (gNB), access node 113 comprises an access mobility function (AMF), session management node 114 comprises a session management function (SMF), and packet routing node 116 comprises a user plane function (UPF). In some 4G examples, base station 111 comprises an eNodeB (eNB), access node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 117 is in communication with an internet protocol (IP) multimedia system (IMS) access gateway (IMS-AGW) 120 within an IMS, in order to provide connectivity to other wireless (cellular) networks, such as for a call with a UE 122 or a public switched telephone system (PSTN, also known as plain old telephone system, POTS). In some examples, proxy node 117 may be considered to be within the IMS. UE 102 reaches network resource 126 using packet data network 124 (or the IMS, in some examples). Data packets of data traffic to/from UE 102 pass through at least base station 111 and packet routing node 116 on their way from/to packet data network 124 or IMS-AGW 120 (via proxy node 117).

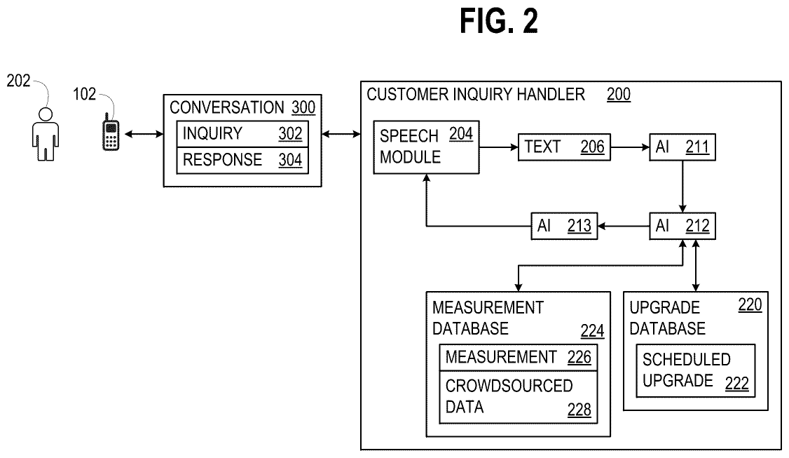

As described more fully below, in relation to the other figures, wireless network 110 has a customer inquiry handler 200 that has uses AI to retrieve data from a database 220 of scheduled equipment upgrades, in order to provide wireless network upgrade inquiry responses to customers. Customer inquiry handler 200 is illustrated as having three AI models, an AI model 211, an AI model 212, and an AI model 213, although one or more of AI models 211-213 may be combined. Customer inquiry handler 200 is shown in further detail in FIG. 2.

Although FIG. 1 and some of the following figures are described using an example of a cellular network, it should be understood that the teachings herein are applicable to other types of wireless networks. To benefit from the teachings herein, another type of wireless network should offer geographically-dispersed radio sites that are subject to scheduled upgrades, and a customer chat capability (text and/or verbal) is provided in which customers may contact the wireless network provider with questions or concerned about wireless network performance. With such a configuration, the teachings herein may extend to the other types of wireless networks.

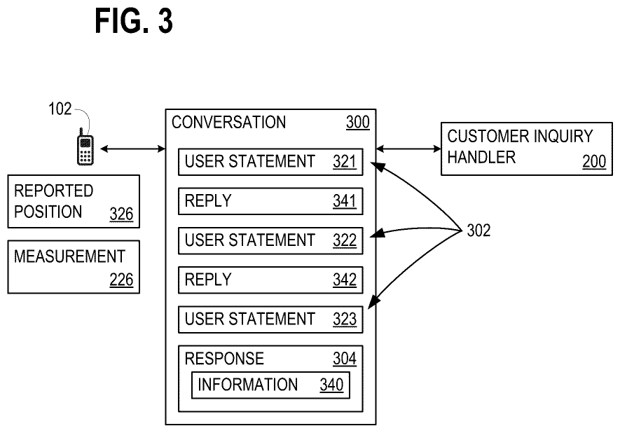

FIG. 2 illustrates a conversation 300 between a customer of wireless network 110 (i.e., a user 202 of UE 102) and customer inquiry handler 200. User 202 uses UE 102 to send an inquiry 302 to customer inquiry handler 200, which responds with a response 304. Conversation 300 includes inquiry 302 and response 304, and is illustrated in further detail in FIG. 3.

Customer inquiry handler 200 has a speech module 204, in some examples, in order to handle verbal conversations 300. Speech module 204 receives an oral inquiry 302, performs speech recognition to generate text 206 of inquiry 302, and then performs text-to-speech to convert response 304 to an oral response. This enables user 202 to have a verbal conversation with customer inquiry handler 200. In some examples, customer inquiry handler 200 handles textual conversations 300, such as a chatbot is able to handle. Some examples provide user 202 with a choice between a textual chat and a verbal conversation.

In general, when customers call a wireless provider, the subject of the conversation may be a billing question, a question about cellphone (or FWA) operation, or a complaint about network performance. When AI model 211 receives text 206 of inquiry 302 (either as a textual chat or converted speech), AI model 211 determines whether inquiry 302 is relevant to performance of wireless network 110. If so, customer inquiry handler 200 determines the location of UE 102 (as described below, in relation to FIG. 3), to identify base station 111 that may be the subject of a performance complaint.

AI model 212 uses a database 220 of scheduled equipment upgrades to determine whether a scheduled equipment upgrade will improve performance of wireless network 110 at the location relevant to inquiry 302 (i.e., base station 111). In the illustrated example, AI model 212 identifies a scheduled equipment upgrade 222 for base station 111. Scheduled equipment upgrade 222 may be any of (including combinations of) increasing bandwidth, increasing UE handling capacity, changing frequencies, restoring performance from a degraded condition, increasing transmit power, and increasing receiver sensitivity.

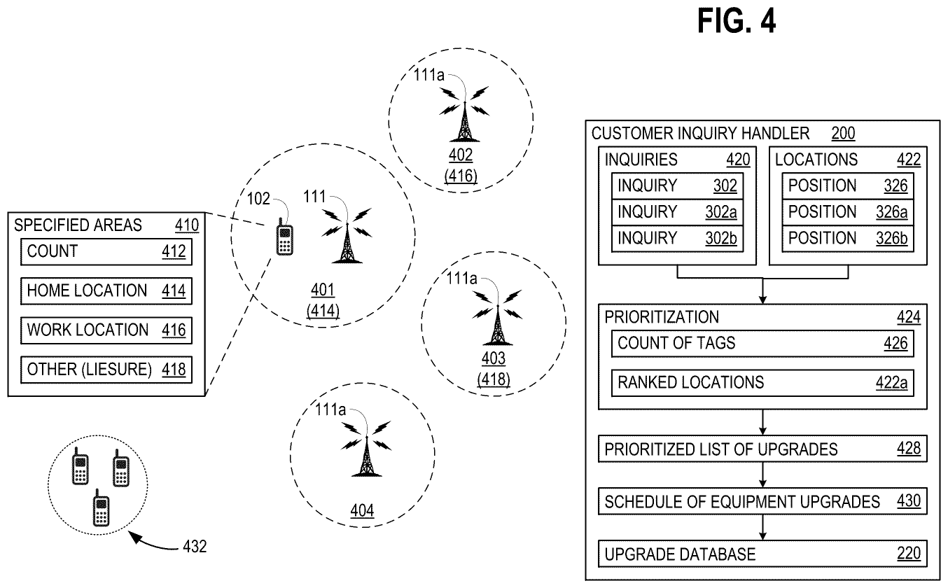

In some examples, customer inquiry handler 200 attempts to verify whether the performance complaint identified in inquiry 302 is valid. This may be accomplished, in some examples, by customer inquiry handler 200 directing UE 102 to submit a measurement 226, such as a radio signal quality measurement, or a data speed test measurement. In some examples, customer inquiry handler 200 (i.e., AI model 212) retrieves crowdsourced data 228 from a database 224 of UE measurements. Crowdsourced data 228 may have been provided by a plurality of UEs 432 (see FIG. 4) that had previously used the same base station. In some examples, measurement 226 is added to database 224 of UE measurements. Upon verification of the network performance issue identified in inquiry 302, AI model 213, which may be generative AI, formulates response 304. Customer inquiry handler 200 returns response 304 to UE 102 (and thus to user 202).

FIG. 3 illustrates further detail for the conversation 300. In some examples, conversation 300 is a multipart conversation with a plurality of user statements 321-323, and a plurality of replies 341 and 342. As illustrated, user 202 starts off with initial user statement 321, which is received by AI model 211. AI model 211 or 213 (which may be the same AI model, in some examples) responds with reply 341 asking for further information. User 202 provides further information in user statement 322, and AI model 211 determines that further information is required. AI model 211 or 213 responds with reply 342 asking for the further information. In this illustrated example, user 202 provides the final required information in user statement 322, and AI models 212 and 213 are able to formulate response 304 with information 340 about scheduled equipment upgrade 222. In this illustrated example, inquiry 302 is a multipart inquiry, comprising user statements 321-323. Some scenarios may require a different number of user statements and replies.

Information 340 about scheduled equipment upgrade 222 may include an expected date of availability of the improved performance, and/or an expected quantification of the improved performance, such as a data rate. Examples may be “On <date>, the data rates in your area will increase 50%, providing you with higher download and upload speeds”, and “The cell towers in your area will introduce new frequencies with higher transmission power, improving your ability to connect.” Other examples of information 340 may include increases in the count of UEs that the base stations may be able to handle, or indication of a new generation of cellular technology becoming available. In some examples, response 304 and information 340 may also be spread throughout replies 341 and 342, rather than being in only a single reply.

In some examples, UE 102 provides a reported position 326, such as its GPS coordinates, or the identity of the serving base station. In some examples, reported position 326 may be within one of user statements 321-323, such as and address provided by user 202 in conversation 300. Measurement 226 may be made and sent by UE 102 contemporaneously with conversation 300.

FIG. 4 illustrates plurality of UEs 432 which are able to provide crowdsourced data 228, and/or a plurality of inquiries 420 that indicate customer concerns about network performance in multiple locations, and which may be used to assist in prioritizing network upgrades. As shown, UE 102 has a data set of specified areas 410 that is used to prioritize areas for requesting improved network performance. A count of locations 412 instructs user 202 to identify three high priority locations, such as their home (a location 414), their primary work area (a location 416), a primary recreation or shopping area (a location 418). Each UE of plurality of UEs 432 is similarly configured.

When UE is in a location 401, which has base station 111 and coincides with location 414, when user 202 submits inquiry 302, inquiry 302 is added to plurality of inquiries 420, and reported position 326 is added to locations 422 relevant to each of plurality of inquiries 420. Plurality of inquiries 420 is shown as also including an inquiry 302a and an inquiry 302b, and locations 422 is shown as also including a reported position 326a and a reported position 326b. These may be collected when UE 102 visits a location 402, which coincides with location 416, and a location 403, which coincides with location 418, and/or when UEs of plurality of UEs 432 visits any of locations 401-404. Location 404 is not within the prioritized set of specified areas 410 for UE 102, but may be within the equivalent set of specified areas 410 for another UE of plurality of UEs 432.

On some trigger event, plurality of inquiries 420 and their relevant locations 422 are provided to a prioritization algorithm 424. Each location is tagged with the number of UEs identifying a network performance issue for that location. Where a larger number of UEs report network performance issues in a common location, a count of tags 426 for that location will be higher than count of tags 426 locations for which a smaller number of UEs reports network performance issues. Prioritization algorithm 424 uses count of tags 426 for each of locations 422 to rank locations 422 into a set of ranked locations 422a. In some examples, prioritization algorithm 424 may be any of gradient boosting, dimensionality reduction, and a decision tree.

Set of ranked locations 422a is used to generate a prioritized list 428 of equipment upgrades, which are scheduled into a schedule 430 of equipment upgrades that is added into database 220 of scheduled equipment upgrades. Schedule 430 of equipment upgrades is then available for use in generating future replies to user inquiries regarding network performance.

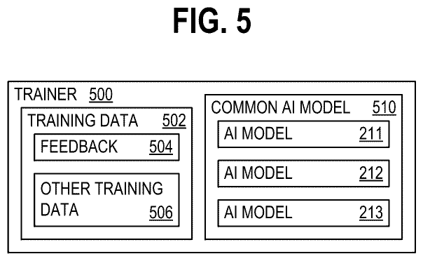

FIG. 5 illustrates training AI models 211-213. A trainer 500 uses training data 502 to train each of AI models 211-213. In some examples, customer inquiry handler 200 (or some other service) solicits feedback 504 from user 202, to identify how informative and relevant response 304 was. Trainer 500 uses feedback 504 to provide reinforcement learning, or some other suitable training, for one or more of AI models 211-213. Training data 502 thus includes feedback 504 and other training data 506.

In some examples, AI models 211-213 are part of a common AI model 510. Some examples may combine AI models 211 and 213, AI models 211 and 212, or AI models 212 and 213 into common AI model 510.

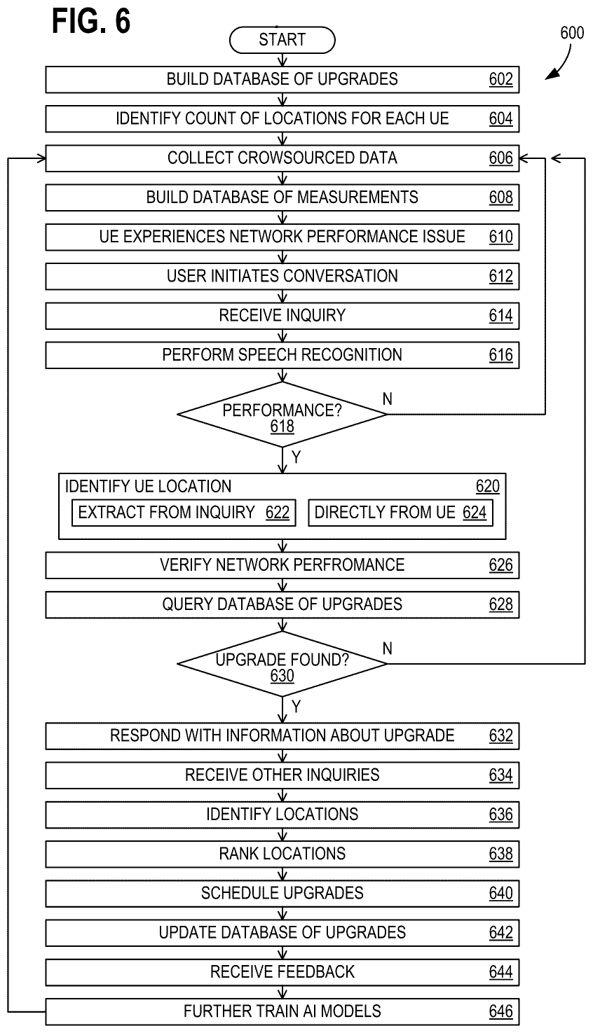

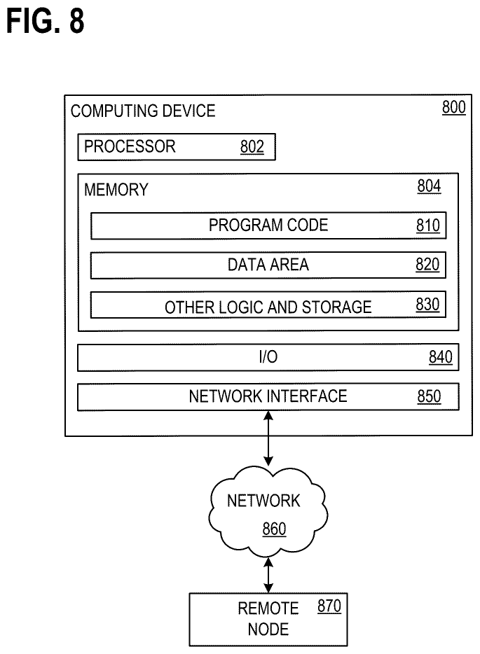

FIG. 6 illustrates a flowchart 600 of exemplary operations associated with architecture 100. In some examples, at least a portion of flowchart 600 may be performed using one or more computing devices 800 of FIG. 8. Flowchart 600 commences with building database 220 of scheduled equipment upgrades in operation 602. Operation 604 Identifies count of locations 412 to be included in plurality of inquiries 420, for each UE of plurality of UEs 432 (including UE 102). In some examples, count of locations 412 is three per UE (e.g., home, work, and a leisure location).

Wireless network 110 collects crowdsourced data 228 in operation 606, and builds database 224 of UE measurements using crowdsourced data 228 in operation 608. Database 224 may include measurement 226, which may be a data rate measurement or a signal quality measurement (e.g., radio frequency power strength).

User 202 (i.e., an account holder of wireless network 110) experiences disappointing wireless network performance while using UE, in operation 610, and initiates conversation 300 in operation 612. Conversation 300 may be a verbal conversation or a textual chat. Customer inquiry handler 200 receives inquiry 302 (i.e., a customer inquiry, which may be verbal or textual and multipart) from UE 102 in operation 614. Operation 616 performs a speech recognition process on inquiry 302 to determine text 206 of inquiry 302, if inquiry 302 is verbal (but is not needed if inquiry 302 is textual).

In decision operation 618, AI model 211 determines whether inquiry 302 is relevant to performance of wireless network 110. If not, flowchart 600 returns to operation 606 to continue collecting crowdsourced data 228. If, however, AI model 211 determines that inquiry 302 is relevant to performance of wireless network 110 in decision operation 618, location 414, within wireless network 110, that is relevant to inquiry 302, is identified in operation 620. This may be performed using operation 622 that identifies location 414 by AI model 211 extracting location 414 from inquiry 302 (i.e., from text 206), or by receiving reported position 326 directly from UE 102 in operation 624.

Operation 626 verifies information provided in inquiry 302 (i.e., the network performance issue, using measurement 226 from UE 102, which is performed contemporaneously with inquiry 302 and/or pulled from database 224 of UE measurements. In operation 628, AI model 212 queries database 220 of scheduled equipment upgrades, to enable decision operation 630 to determine whether any equipment upgrade is scheduled (e.g., scheduled equipment upgrade 222) that will improve performance of wireless network 110 at location 414 (i.e., the location that is relevant to inquiry 302). In some examples, scheduled equipment upgrade 222 comprises a network activity selected from the list consisting of: increasing bandwidth, increasing UE handling capacity, changing frequencies, restoring performance from a degraded condition, increasing transmit power, and increasing receiver sensitivity.

If no relevant scheduled upgrades are found, flowchart 600 returns to operation 606. However, if scheduled equipment upgrade 222 is found, in operation 632, AI model 213 responds to inquiry 302 with information 340 about scheduled equipment upgrade 222, in response 304. If conversation 300 is textual, response 304 is a textual response, although if conversation 300 is verbal, response 304 is converted to speech and is a verbal response. In some examples, information 340 about scheduled equipment upgrade 222 includes an expected date of availability of the improved performance and/or an expected quantification of the improved performance, such as a data rate.

In order to use architecture 100 in planning for customer experience improvement, plurality of inquiries 420, each relevant to performance of wireless network 110, is received from plurality of UEs 432 in operation 634. Operation 636 identifies locations 422 relevant to each of plurality of inquiries 420. Operation 638 ranks locations 422 for prioritizing equipment upgrades, based on at least plurality of inquiries 420. In some examples, this involves tagging each location for each inquiry, determining count of tags 426 for each location, and/or using prioritization algorithm 424. Operation 640 schedules equipment upgrades based on at least the ranking of locations 422, and operation 642 enters schedule 430 of equipment upgrades into database 220 of scheduled equipment upgrades.

In order to continuously improve the operation of AI models within customer inquiry handler 200, operation 644 solicits and receives feedback for response 304 to inquiry 302, and operation 646 performs reinforcement learning, using feedback 504, for AI model 211 or AI model 212 or AI model 213.

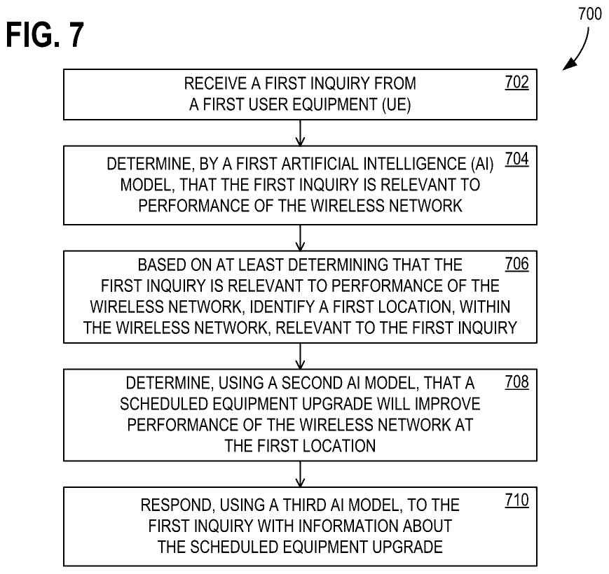

FIG. 7 illustrates a flowchart 700 of exemplary operations associated with examples of architecture 100. In some examples, at least a portion of flowchart 700 may be performed using one or more computing devices 800 of FIG. 8. Flowchart 700 commences with operation 702, which includes receiving a first inquiry from a first UE. Operation 704 includes determining, by a first AI model, that the first inquiry is relevant to performance of the wireless network.

Operation 706 includes, based on at least determining that the first inquiry is relevant to performance of the wireless network, identifying a first location, within the wireless network, relevant to the first inquiry. Operation 708 includes determining, using a second AI model, that a scheduled equipment upgrade will improve performance of the wireless network at the first location. Operation 710 includes responding, using a third AI model, to the first inquiry with information about the scheduled equipment upgrade.

FIG. 8 illustrates a block diagram of computing device 800 that may be used as any component described herein that may require computational or storage capacity. Computing device 800 has at least a processor 802 and a memory 804 that holds program code 810, data area 820, and other logic and storage 830. Memory 804 is any device allowing information, such as computer executable instructions and/or other data, to be stored and retrieved. For example, memory 804 may include one or more random access memory (RAM) modules, flash memory modules, hard disks, solid-state disks, persistent memory devices, and/or optical disks. Program code 810 comprises computer executable instructions and computer executable components including instructions used to perform operations described herein. Data area 820 holds data used to perform operations described herein. Memory 804 also includes other logic and storage 830 that performs or facilitates other functions disclosed herein or otherwise required of computing device 800. An input/output (I/O) component 840 facilitates receiving input from users and other devices and generating displays for users and outputs for other devices. A network interface 850 permits communication over external computer network 860 with a remote node 870, which may represent another implementation of computing device 800. For example, a remote node 870 may represent another of the above-noted nodes within architecture 100.

### ADDITIONAL EXAMPLES

An example system comprises: a processor; and a computer-readable medium storing instructions that are operative upon execution by the processor to: receive a first inquiry from a first UE; determine, by a first AI model, that the first inquiry is relevant to performance of the wireless network; based on at least determining that the first inquiry is relevant to performance of the wireless network, identify a first location, within the wireless network, relevant to the first inquiry; determine, using a second AI model, that a scheduled equipment upgrade will improve performance of the wireless network at the first location; and respond, using a third AI model, to the first inquiry with information about the scheduled equipment upgrade.

An example method comprises: receiving a first inquiry from a first UE; determining, by a first AI model, that the first inquiry is relevant to performance of the wireless network; based on at least determining that the first inquiry is relevant to performance of the wireless network, identifying a first location, within the wireless network, relevant to the first inquiry; determining, using a second AI model, that a scheduled equipment upgrade will improve performance of the wireless network at the first location; and responding, using a third AI model, to the first inquiry with information about the scheduled equipment upgrade.

One or more example computer storage devices has computer-executable instructions stored thereon, which, upon execution by a computer, cause the computer to perform operations comprising: receiving a first inquiry from a first UE; determining, by a first AI model, that the first inquiry is relevant to performance of the wireless network; based on at least determining that the first inquiry is relevant to performance of the wireless network, identifying a first location, within the wireless network, relevant to the first inquiry; determining, using a second AI model, that a scheduled equipment upgrade will improve performance of the wireless network at the first location; and responding, using a third AI model, to the first inquiry with information about the scheduled equipment upgrade.

Alternatively, or in addition to the other examples described herein, examples include any combination of the following:
the wireless network comprises a cellular network;
the first UE comprises an FWA device or an eMBB device;
verifying, using a measurement from the first UE performed contemporaneously with the first inquiry and/or from a database of UE measurements, information provided in the first inquiry;
the measurement comprises a data rate measurement or a signal quality measurement;
receiving a plurality of inquiries, each relevant to performance of the wireless network, from a plurality of UEs;
identifying locations, within the wireless network, relevant to each of the plurality of inquiries;
ranking the locations for prioritizing equipment upgrades, based on at least the plurality of inquiries;
identifying, for each UE of the plurality of UEs, a count of locations to be included in the plurality of inquiries;
receiving feedback for the response to the first inquiry;
performing reinforcement learning, using the feedback, for the first AI model or the second AI model or the third AI model;
the first AI model and the third AI model are within a common AI model;
the first AI model and the second AI model are within the common AI model;
the first inquiry comprises a textual inquiry;
responding to the first inquiry comprises using a textual response;
the first inquiry comprises a verbal inquiry;
performing a speech recognition process on the first inquiry to determine text of the first inquiry;
responding to the first inquiry comprises using a text to speech process;
the first inquiry comprises a customer inquiry from an account holder of the wireless network;
the first inquiry comprises a multipart conversation between the first AI model and a user of the first UE;
determining whether the first inquiry is relevant to performance of the wireless network;
the first AI model identifies the first location within the first inquiry;
identifying the first location comprises receiving a reported position from the first UE;
identifying the first location comprises extracting the first location from the first inquiry;
determining whether a scheduled equipment upgrade will improve performance of the wireless network at the first location;
determining whether a scheduled equipment upgrade will improve performance of the wireless network at the first location comprises querying a database of scheduled equipment upgrades;
the scheduled equipment upgrade comprises a network activity selected from the list consisting of: increasing bandwidth, increasing UE handling capacity, changing frequencies, restoring performance from a degraded condition, increasing transmit power, and increasing receiver sensitivity;
the information about the scheduled equipment upgrade comprises an expected date of availability of the improved performance;
the information about the scheduled equipment upgrade comprises an expected quantification of the improved performance;
the expected quantification of the improved performance comprises a data rate;
the plurality of inquiries includes the first inquiry;
ranking the locations comprises using a prioritization algorithm selected from the list consisting of: gradient boosting, dimensionality reduction, and a decision tree;
ranking the locations comprises tagging each location for each inquiry and determining a count of tags for each location;
scheduling equipment upgrades based on at least the ranking of the locations;
entering a schedule of equipment upgrades into the database of scheduled equipment upgrades; and
the count of locations to be included in the plurality of inquiries is three per UE.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
receiving a first inquiry from a first user equipment (UE);
determining, by a first artificial intelligence (AI) model, that the first inquiry is relevant to performance of a wireless network;
based on at least determining that the first inquiry is relevant to performance of the wireless network, identifying a first location, within the wireless network, relevant to the first inquiry;
determining, using a second AI model, that a scheduled equipment upgrade will improve performance of the wireless network at the first location; and
responding, using a third AI model, to the first inquiry with information about the scheduled equipment upgrade.

2. The method of claim 1, further comprising:
verifying, using a measurement from the first UE performed contemporaneously with the first inquiry and/or from a database of UE measurements, information provided in the first inquiry, wherein the measurement comprises a data rate measurement or a signal quality measurement.

3. The method of claim 1, further comprising:
receiving a plurality of inquiries, each relevant to performance of the wireless network, from a plurality of UEs;
identifying locations, within the wireless network, relevant to each of the plurality of inquiries; and
ranking the locations for prioritizing equipment upgrades, based on at least the plurality of inquiries.

4. The method of claim 3, further comprising:
identifying, for each UE of the plurality of UEs, a count of locations to be included in the plurality of inquiries.

5. The method of claim 1, further comprising:
receiving feedback for the response to the first inquiry; and
performing reinforcement learning, using the feedback, for the first AI model or the second AI model or the third AI model.

6. The method of claim 1, wherein the first AI model and the third AI model are within a common AI model, and/or wherein the first AI model and the second AI model are within the common AI model.

7. The method of claim 1,
wherein the first inquiry comprises a textual inquiry and responding to the first inquiry comprises using a textual response; or
wherein the first inquiry comprises a verbal inquiry, and the method further comprises:
performing a speech recognition process on the first inquiry to determine text of the first inquiry, wherein responding to the first inquiry comprises using a text to speech process.

8. A system comprising:
a processor; and
a computer-readable medium storing instructions that are operative upon execution by the processor to:
receive a first inquiry from a first user equipment (UE);
determine, by a first artificial intelligence (AI) model, that the first inquiry is relevant to performance of a wireless network;
based on at least determining that the first inquiry is relevant to performance of the wireless network, identify a first location, within the wireless network, relevant to the first inquiry;
determine, using a second AI model, that a scheduled equipment upgrade will improve performance of the wireless network at the first location; and
respond, using a third AI model, to the first inquiry with information about the scheduled equipment upgrade.

9. The system of claim 8, wherein the instructions are further operative to:
verify, using a measurement from the first UE performed contemporaneously with the first inquiry and/or from a database of UE measurements, information provided in the first inquiry, wherein the measurement comprises a data rate measurement or a signal quality measurement.

10. The system of claim 8, wherein the instructions are further operative to:
receive a plurality of inquiries, each relevant to performance of the wireless network, from a plurality of UEs;
identify locations, within the wireless network, relevant to each of the plurality of inquiries; and
rank the locations for prioritizing equipment upgrades, based on at least the plurality of inquiries.

11. The system of claim 10, wherein the instructions are further operative to:
identify, for each UE of the plurality of UEs, a count of locations to be included in the plurality of inquiries.

12. The system of claim 8, wherein the instructions are further operative to:
receive feedback for the response to the first inquiry; and
perform reinforcement learning, using the feedback, for the first AI model or the second AI model or the third AI model.

13. The system of claim 8, wherein the first AI model and the third AI model are within a common AI model, and/or wherein the first AI model and the second AI model are within the common AI model.

14. The system of claim 8, wherein the instructions are further operative to:
wherein the first inquiry comprises a textual inquiry and responding to the first inquiry comprises using a textual response; or
wherein the first inquiry comprises a verbal inquiry, and the instructions are further operative to:
perform a speech recognition process on the first inquiry to determine text of the first inquiry, wherein responding to the first inquiry comprises using a text to speech process.

15. One or more computer storage devices having computer-executable instructions stored thereon, which, upon execution by a computer, cause the computer to perform operations comprising:
receiving a first inquiry from a first user equipment (UE);
determining, by a first artificial intelligence (AI) model, that the first inquiry is relevant to performance of a wireless network;
based on at least determining that the first inquiry is relevant to performance of the wireless network, identifying a first location, within the wireless network, relevant to the first inquiry;
determining, using a second AI model, that a scheduled equipment upgrade will improve performance of the wireless network at the first location; and
responding, using a third AI model, to the first inquiry with information about the scheduled equipment upgrade.

16. The one or more computer storage devices of claim 15, wherein the operations further comprise:
verifying, using a measurement from the first UE performed contemporaneously with the first inquiry and/or from a database of UE measurements, information provided in the first inquiry, wherein the measurement comprises a data rate measurement or a signal quality measurement.

17. The one or more computer storage devices of claim 15, wherein the operations further comprise:
receiving a plurality of inquiries, each relevant to performance of the wireless network, from a plurality of UEs;
identifying locations, within the wireless network, relevant to each of the plurality of inquiries; and
ranking the locations for prioritizing equipment upgrades, based on at least the plurality of inquiries.

18. The one or more computer storage devices of claim 17, wherein the operations further comprise:
identifying, for each UE of the plurality of UEs, a count of locations to be included in the plurality of inquiries.

19. The one or more computer storage devices of claim 15, wherein the operations further comprise:
receiving feedback for the response to the first inquiry; and
performing reinforcement learning, using the feedback, for the first AI model or the second AI model or the third AI model.

20. The one or more computer storage devices of claim 15, wherein the information about the scheduled equipment upgrade comprises an expected date of availability of the improved performance, and wherein the information about the scheduled equipment upgrade comprises an expected quantification of the improved performance.
